(19) United States
(12) Patent Application Publication
(10) Pub. No.: US 2002/0191122 A1
(43) Pub. Date: Dec. 19, 2002

(54) Method of forming electrodes or pixel electrodes and a liquid crystal display device

(76) Inventors: Hideo Tanaka, Nishiku (JP); Yoshihisa Hatta, Nishiku (JP)

Correspondence Address: US Philips Corporation, Intellectual Property Department, 580 White Plains Road, Tarrytown, NY, 10591, US

(21) Appl. No.: 10/148,045

(22) PCT Filed: Sep. 26, 2001
(86) PCT No.: PCT/EP01/11166

(30) Foreign Application Priority Data
Sep. 27, 2000 (JP) 2000-293686

(51) Int. Cl. G02F 1/136

(52) U.S. Cl. 349/43

(57) ABSTRACT

In accordance with the invention, a planarization film 9 is exposed using a photo mask 20 and then it is developed, so that the planarization film 9 is provided with recesses 9b. Finally, pixel electrodes 10 are formed on the planarization film 9 comprising those recesses 9b.

### TECHNICAL FIELD

The invention relates to a method of forming an electrode to be formed on a light-sensitive film, a method of forming a pixel electrode and a liquid crystal display device.

### BACKGROUND OF THE INVENTION

As commonly known, there are two types of liquid crystal display devices: a transmissive type of liquid crystal display device provided with backlight and a reflective type of liquid crystal display device utilizing external light. The reflective type liquid crystal display device is provided with pixel electrodes comprising Al or Ag metal that has a high reflectivity property, in order to reflect the external light. Especially, such reflective liquid crystal display device may needs to scatter the external light in various directions in order to improve the quality of the image to be displayed. For that purpose, the pixel electrodes are usually provided with recesses/projections. In accordance with such pixel electrodes provided with recesses/projections, the external light could be scattered in various directions. Following will briefly explain an example of conventional methods of forming pixel electrodes comprising recesses/projections.

At first, the example conventional method may form semiconductor elements such as TFTs at the respective positions corresponding to respective pixel on a substrate (e.g, a glass substrate). Then, the method may form a plurality of projection members which are used to provide a pixel electrode with recesses/projections, and may further form a planarization film so as to cover the plurality of projection members with the planarization film. Since there exist a plurality of projection members below the planarization film, the planarization film is provided with recesses/projections under the influence of the existence of the plurality of projection members. Then, when pixel electrodes are formed on that planarization film, the pixel electrodes are provided with recesses/projections under the influence of the recesses/projections of the planarization film.

However, the above-mentioned conventional method has a problem that the method needs a rather expensive fabrication cost because the method requires to form not only the planarization film but also many projection members in order to provide the pixel electrodes with recesses/projections.

From a viewpoint of the aforementioned situation, it is an objective of the invention to provide a liquid crystal display device and methods of forming an electrode and a pixel electrode at a low cost of manufacturing.

### SUMMARY OF THE INVENTION

In order to achieve the above-described objective, the invention provides a method of forming an electrode. The method comprises a first step of forming a light-sensitive film having light-sensitivity, a second step of exposing said light-sensitive film so that a different amount of exposure energies can be applied to a certain region and another region of said light-sensitive film, a third step of developing said exposed light-sensitive film; and a fourth step of forming electrodes on said developed light-sensitive film.

This method of forming an electrode in accordance with the invention, in the second step, exposes said light-sensitive film so that a different amount of exposure energies can be applied to different regions of said light-sensitive film. Hence, by developing this light-sensitive film in the third process, recesses having different depth can be formed in the surface of the light-sensitive film. The depth of the recess can be changed by means of adjusting the amount of exposure energies to be applied to the light-sensitive film, so that the recess having desired depth could be formed in the surface of the light-sensitive film. Therefore, if an electrode is formed on the planarization film comprising such recesses, the electrode may follow the surface shape of the planarization film, so that the electrode is provided with recesses/projections. Thus, in accordance with the inventive method of forming an electrode, it is possible to provide an electrode with recesses/projections by forming recesses in the light-sensitive film itself. Consequently, in the case of forming an electrode having recesses/projections, the inventive method need to form this light-sensitive film but does not need to form any projection members for providing this light-sensitive film with recesses/projections, so that the cost could be decreased.

The invention also provides a method of forming pixel electrodes at positions corresponding respectively to pixels on a substrate. The method comprises a first step of forming semiconductor elements at positions corresponding respectively to pixels on said substrate, a second step of forming a light-sensitive film having light-sensitivity on said substrate on which said semiconductor elements have been formed, a third step of exposing said light-sensitive film so that a different amount of exposure energies can be applied to a certain region and another region of said light-sensitive film, a fourth step of developing said exposed light-sensitive film and a fifth step of forming said pixel electrodes on said developed light-sensitive film.

This method of forming pixel electrodes in accordance with the invention, in the third step, exposes said light-sensitive film so that a different amount of exposure energies can be applied to different regions of said light-sensitive film. Hence, by means of adjusting the amount of exposure energies to be applied to regions of the light-sensitive film, recesses having desired depth could be formed in the surface of the light-sensitive film. Therefore, when pixel electrodes are formed on the light-sensitive film comprising such recesses, the pixel electrodes can be provided with recesses/projections without forming projection members below the light-sensitive film. Thus, for example, in the case of manufacturing a reflective type liquid crystal display device by using the method of forming pixel electrodes in accordance with the invention, the reflective type liquid crystal display device could be manufactured at a low manufacturing cost.

Preferably, the above-mentioned method of forming pixel electrodes may further comprises a sixth step, after said first step before said second step, of forming a single-layer film or a multiple-layer film on said substrate so as to cover said semiconductor elements with said single-layer film or multiple-layer.

By forming a single-layer film or a multiple-layer film before forming the light-sensitive film, the characteristics of the semiconductor elements can be prevented from changing since the single-layer film or multiple-layer exists between the semiconductor elements and the light-sensitive film.

Besides, the invention discloses a liquid crystal display device provided with a substrate on which semiconductor elements are formed at positions corresponding respectively to pixels. The device comprises a light-sensitive film formed on said substrate and the light-sensitive film has a plurality of recesses at each of position corresponding respectively to pixels. Further, the device comprises pixel electrodes formed at positions corresponding respectively to pixels so as to cover said plurality of recesses of said light-sensitive film with said pixel electrodes.

### BRIEF DESCRIPTION OF THE DRAWINGS

FIG. 1 is an enlarged cross-sectional view of a portion, corresponding to one pixel, on a substrate used for a liquid crystal display device;

FIG. 2 illustrates an enlarged cross-sectional view of the substrate portion shown in FIG. 1 after the TFT has been formed therein;

FIG. 3 illustrates an enlarged cross-sectional view of the same substrate portion when the planarization film 9 is being light-exposed;

FIG. 4 illustrates an enlarged cross-sectional view of the same substrate portion after the planarization film 9 has been developed;

FIG. 5 illustrates an enlarged cross-sectional view of the same substrate portion after the contact hole 8a has been formed in the passivation film 8;

FIG. 6 illustrates a cross-sectional view of a TFT in which a pixel electrode has been formed in accordance with the conventional method; and

FIG. 7 illustrates a cross-sectional view of an exemplary TFT without the passivation film.

### DETAILED DESCRIPTION OF THE INVENTION

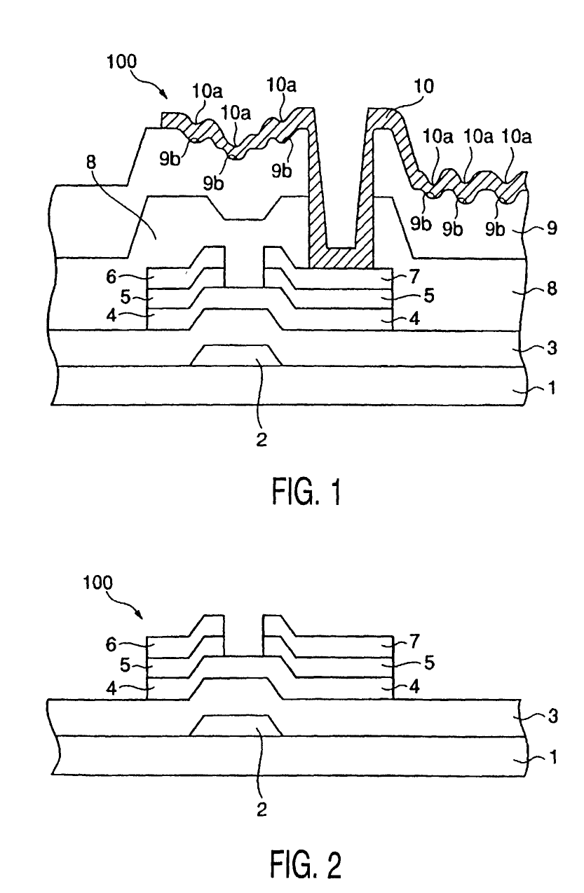

Referring to FIGS. 1 to 5, an embodiment of the invention is illustrated in which pixel electrodes to be formed at positions corresponding respectively to pixels are formed on a substrate used in a liquid crystal display. However, it should be noted that the invention may be applied to any other device than the liquid crystal display device as long as such device requires an electrode having recesses/projections.

FIG. 1 is an enlarged cross-sectional view of a portion, corresponding to one pixel, on a substrate used for a liquid crystal display device. Following will explain a method of manufacturing this portion corresponding to that pixel with reference to FIG. 1 as well as FIG. 2 through FIG. 5. FIG. 2 through FIG. 5 illustrate steps of manufacturing the portion corresponding to the pixel shown in FIG. 1.

At first, a TFT 100 may be formed on a glass substrate 1 as illustrated in FIG. 2. The TFT 100 may be manufactured on the glass substrate 1 by forming a gate electrode 2, a gate insulating film 3, a semiconductor layer 4 (e.g, a-Si:H or a-Si:H:F), an ohmic contact layer 5, a source electrode 6 and a drain electrode 7. Forming the semiconductor layer 4, the ohmic contact layer 5, the source electrode 6 and the drain electrode 7 can be performed in accordance with various methods. For example, after the semiconductor layer 4 has been formed, a material for the ohmic contact layer 5 and a material for the source electrode 6 and the drain electrode 7 may be deposited in sequence, and then these deposited materials may be etched in sequence so that the ohmic contact layer 5, the source electrode 6 and the drain electrode 7 could be formed.

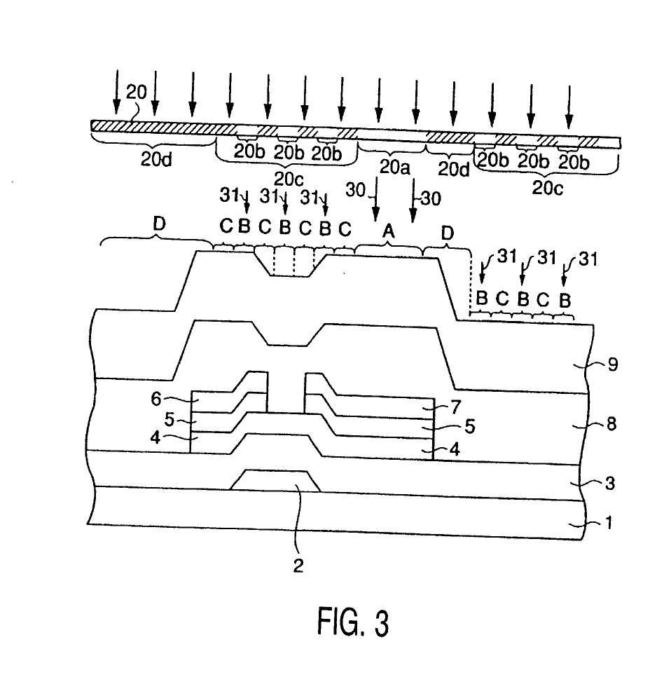

Then, a passivation film 8 and a positive type of planarization film 9 having a light-sensitivity may be formed in sequence as illustrated in FIG. 3. It should be noted that this planarization film 9 represents a light-sensitive film as claimed in this invention. The formation of the passivation film 8 below the planarization film 9 can effectively prevent the characteristics of the TFT 100 from deteriorating. After forming the planarization film 9, the planarization film 9 is exposed to light using a photo mask 20. The planarization film 9 is exposed to light in such manner that a stronger exposure energy is applied to a region A of the planarization film 9 while a less exposure energy is applied to a region B. In order to expose the planarization film 9 as mentioned above, the part of photo mask 20 corresponding to the region A is provided with an opening 20a and the part of photo mask 20 corresponding to the regions B and C is provided with slit portion 20c. The width of the opening 20a of the photo mask 20 is larger than the resolution of the exposing system, and the slit portion 20c comprises slits 20b each of which has a width smaller than the resolution of the exposing system. Since the width of the opening 20a of the photo mask 20 is larger than the resolution of the exposing system, the region A of the planarization film 9 receives the light 30 having the higher intensity. On the other hand, since the slit portion 20c of the photo mask 20 comprises the slit 20b, the light passing through these slits 20b is diffracted so that the light which are intensified together and the lights which are weakened together are produced. At this time, the regions B receive the intensified lights but the regions C sandwiched by the regions B receive the weakened lights. That is, the regions B receive the intensified lights 31 but the regions C receive almost no light. Besides, since the width of the slits 20b is smaller than the resolution of the exposing system, the intensity of the lights 31 irradiated onto the regions B is smaller than that of the light 30 irradiated onto the region A. Furthermore, the part of the photo mask 20 except for the opening 20a and the slit portion 20c is light-shielding portions 20d for shielding the light, so that the regions D opposing the light-shielding portions 20d receive no light. Thus, by means of the photo mask 20, no light may be irradiated onto the regions C and the regions D, the strong light 30 is irradiated onto the region A and the weak lights are irradiated onto the regions B. In other words, with the photo mask 20, the stronger exposure energy is applied to the region A while the weaker exposure energy is applied to the regions B. After the planarization film 9 has been exposed to light as explained above, the planarization film 9 may be developed.

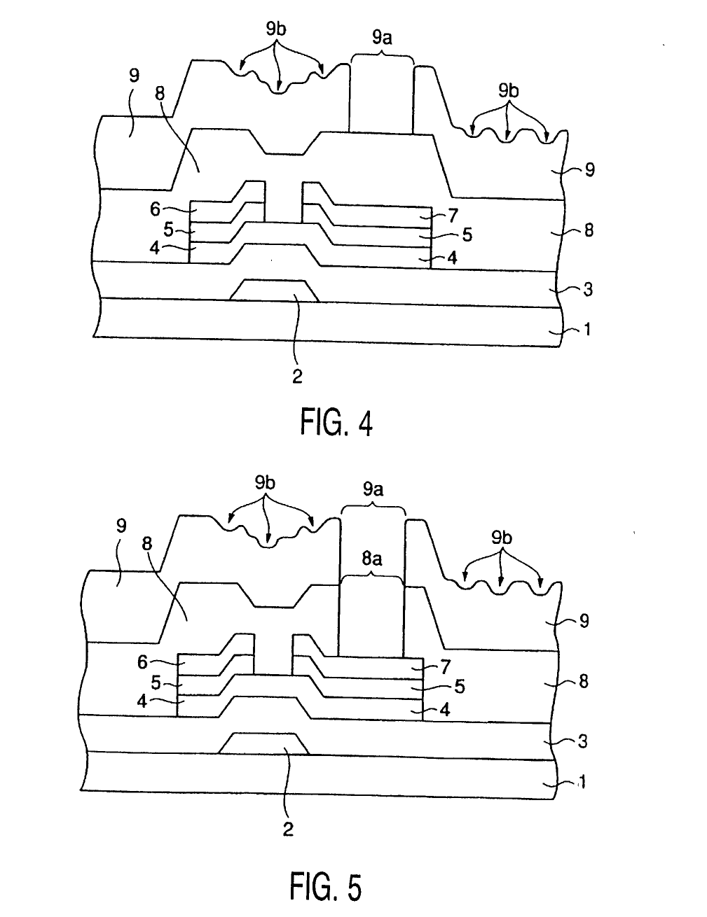

FIG. 4 is a cross-sectional view of the substrate after the planarization film 9 has been developed. As shown in FIG. 4, the regions D (see FIG. 3) of the planarization film 9 may remain unremoved even after the planarization film 9 have been developed because no light may be irradiated onto those regions D under the influence of the light-shielding portion 20d of the photo mask 20. In contrast, the region A of the planarization film 9 is removed after the development of the smoothing film 9 because the stronger light has been irradiated onto the region A, so that a passivation film 8 is exposed and a contact hole 9a is formed. Besides, the regions C of the planarization film 9 may substantially remain unremoved even after the planarization film 9 have been developed because almost no light is irradiated onto the regions C under the influence of the slit portions 20c of the photo mask 20, whereas the surface of the regions B of the planarization film 9 are removed and recesses 9b are formed after the planarization film 9 have been developed because the weaker lights 31 have been irradiated onto the regions B.

After developing the planarization film 9, the passivation film 8 is dry-etched with the planarization film 9 having a contact hole 9a and recesses 9b acting as an etch mask, so that a drain electrode 7 is exposed and a contact hole 8a is formed within the passivation film 8 as illustrated in FIG. 5.

After dry-etching the passivation film 8, an AlCu film mainly containing Al is formed on the planarization film 9 by means of a sputtering or evaporation method and then a pattern of pixel electrode 10 (refer to FIG. 1) is defined in the AlCu film. As a result, a pixel electrode 10 may be formed as illustrated in FIG. 1. Since the planarization film 9 formed below this pixel electrode 10 comprises recesses 9b, the pixel electrode 10 is provided with recesses 10a under the influence of the recesses 9b of the planarization film 9. To provide the pixel electrode 10 with recesses 10a leads to form recesses/projections in the surface of the pixel electrode 10

In accordance with this embodiment of the invention, the regions B are irradiated with the weaker lights when the planarization film 9 is exposed to the light. Accordingly, the development of this planarization film 9 can produce recesses 9b in the surface of this planarization film 9. Because the pixel electrode 10 is formed on the planarization film 9 comprising recesses 9b, the pixel electrode 10 may follow the surface shape of the planarization film 9, so that the pixel electrode 10 can be provided with recesses/projections in the surface of this pixel electrode 10. Thus, in accordance with the embodiment of the invention, the surface of pixel electrode 10 is provided with recesses/projectionss by means of forming recesses 9b in the planarization film 9 itself.

On the other hand, the conventional way need to form not only planarization film 9 but also projection members for providing this planarization film 9 with recesses/projections in order to provide the surface of the pixel electrode 10 with recesses/projections.

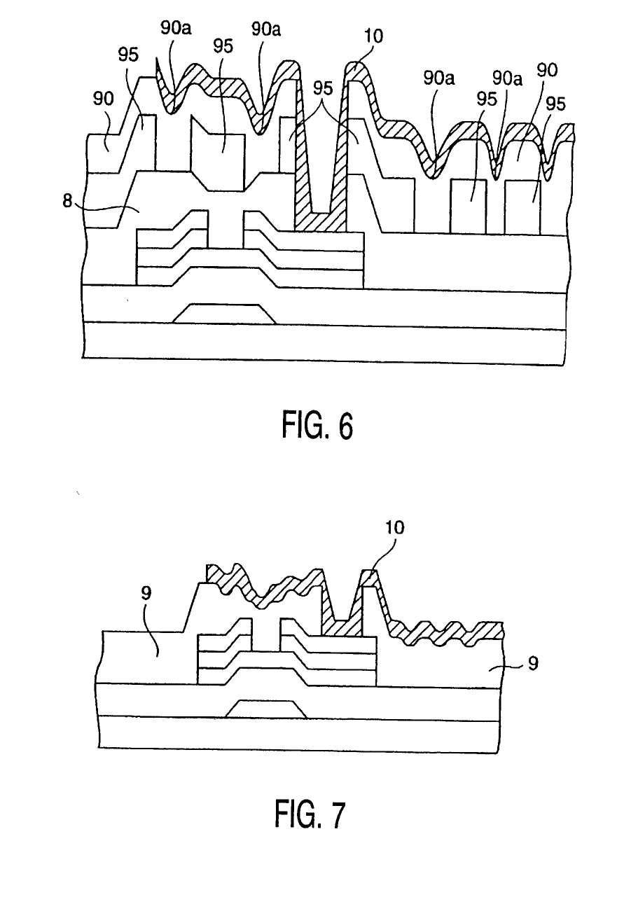

FIG. 6 illustrates a cross-sectional view of a TFT in which a pixel electrode is formed in accordance with such conventional method. In the conventional method, for the purpose of providing a planarization film 90 with recesses 90a, a plurality of projection members 95 are formed before forming the planarization film 90. The planarization film 90 is provided with recesses 90a under the influence of the plurality of projection members 95. Accordingly, it is possible to form a pixel electrode 10 comprising recesses/projections by forming this pixel electrode 10 on the planarization film 90 comprising the recesses 90a. However, there exists a problem of increasing the number of manufacturing steps and the high cost of manufacturing in the conventional method, since the conventional method need to form not only the planarization film 90 but also projection members 95 for providing this planarization film 90 with recesses 90a. In contrast, in accordance with the embodiment of the invention, it is possible to form recesses 9b in the surface of the planarization film 9 by means of changing the amount of the respective exposure energies to be applied to the regions A, B, C and D of the planarization film 9 when the planarization film 9 is exposed to the light. Therefore, the embodiment of the invention does not need to form such projection members 95 illustrated in FIG. 6 in addition to the planarization film 9, so that the number of the manufacturing steps could be reduced and accordingly the cost of manufacturing could be decreased.

In FIG. 1, the passivation film 8 is provided as a single layer between the TFT 100 (see FIG. 2) and the planarization film 9. However, it is possible to provide a plurality of passivation films or a plurality of films which are different from passivation films. Besides, although the passivation film 8 is formed below the planarization film 9 in FIG. 1, this passivation film 8 may not necessarily be required.

FIG. 7 illustrates a cross-sectional view of the TFT in which the passivation film 8 is not formed. In case where the passivation film 8 is not formed, it could be expected that the substrate might advantageously become thinner correspondingly to the exclusion of the passivation film 8, in addition to the reduced number of the manufacturing steps and the decreased cost.

In this embodiment of the invention, a positive type of planarization film 9 is used. Accordingly, when the planarization film 9 is exposed to the light in order to form recesses 9b on the planarization film 9, less exposure energy must be applied to the regions B of the planarization film 9 than the region A. For this purpose, in the embodiment of the invention, the photo mask 20 comprising the slit portions 20c is used when the planarization film 9 is exposed to the light. However, it may be possible to apply different strength of the exposure energies to the regions A and B even if any other exposure is used which is different from the exposure method using the photo mask 20 comprising slit portions 20c. Such other exposure method includes, for example, an exposure method using a photo mask in which the portion of the photo mask corresponding to the region B has smaller light transmittivity than that of the portion of the photo mask corresponding to the region A, and an exposure method using a plurality of photo masks in which respective patterns of the photo masks are different each other.

It should be further noted that although a positive type is used for the planarization film 9, a negative type may be used. In case of using the negative type planarization film instead of positive type planarization film, no light might be irradiated on the region A of the negative type planarization film but rather intensified lights might be irradiated onto the regions D in contrast to positive type planarization film.

It should be also noted that although AlCu is used as a material for the pixel electrode 10 in the embodiment of the invention, Ag and any other material may be alternatively used.

As above explained, the method of forming electrodes, the method of forming pixel electrodes and the liquid crystal display device in accordance with the invention can decrease the cost of manufacturing.

1. A method of forming an electrode, comprising:
a first step of forming a light-sensitive film having light-sensitivity;
a second step of exposing said light-sensitive film so that a different mount of exposure energies can be applied to a certain region and another region of said light-sensitive film;
a third step of developing said exposed light-sensitive film; and
a fourth step of forming electrodes on said developed light-sensitive film.

2. A method of forming pixel electrodes at positions corresponding respectively to pixels on a substrate, comprising:
a first step of forming semiconductor elements at positions corresponding respectively to pixels on said substrate;
a second step of forming a light-sensitive film having light-sensitivity on said substrate on which said semiconductor elements have been formed;
a third step of exposing said light-sensitive film so that a different amount of exposure energies can be applied to a certain region and another region of said light-sensitive film;
a fourth step of developing said exposed light-sensitive film; and
a fifth step of forming said pixel electrodes on said developed light-sensitive film.

3. A method as claimed in claim 2, further comprising a sixth step, after said first step before said second step, of forming a single-layer film or a multiple-layer film on said substrate so as to cover said semiconductor elements with said single-layer film or multiple-layer.

4. A liquid crystal display device provided with a substrate on which semiconductor elements are formed at positions corresponding respectively to pixels, comprising:
a light-sensitive film formed on said substrate, said light-sensitive film having a plurality of recesses at each of position corresponding respectively to pixels; and
pixel electrodes formed at positions corresponding respectively to pixels so as to cover said plurality of recesses of said light-sensitive film with said pixel electrodes.
